(19) United States
(12) Patent Application Publication
(10) Pub. No.: US 2005/0056437 A1
(43) Pub. Date: Mar. 17, 2005

(54) Pick

(76) Inventors: Andrew Joseph Gaudielle, Billings, MT (US); George Allen Crow, Tucson, AZ (US)

Correspondence Address: Andrew Gaudielle, 4316 Huckleberry Lane S., Billings, MT, 59106, US

(21) Appl. No.: 10/938,649

(22) Filed: Sep. 13, 2004

Related U.S. Application Data
(60) Provisional application No. 60/502,853, filed on Sep. 15, 2003.

(51) Int. Cl. A01B 1/00

(52) U.S. Cl. 172/371

(57) ABSTRACT

A pick comprises a handle and a pick head coupled to the handle at an acute angle thereto. The pick head has a top, and first and second side edges, which extend away from the top and meet at a bottom point. The pick head includes at least one tab extending from the pick head top toward the handle. The tab has a length sufficient to serve as a foot support and as a striking surface.

In accordance with 35 U.S.C. §119(e), this non-provisional application claims the benefit of U.S. provisional application 60/502,853 filed Sep. 15, 2003.

### BACKGROUND

A need has been established for a multiple purpose earth-working tool. In particular there is a need for an earth-working pick which can be used for digging in many different environments from soft uncompacted soils to hard compacted soils and rocky deposits.

### SUMMARY

The present invention satisfies the aforementioned need for a multiple purpose earth working pick which can be used for digging in many different environments from soft uncompacted soils to hard compacted soils and rocky deposits.

One aspect of the invention is a pick which comprises a handle comprising an elongate shaft having first and second ends disposed generally along a longitudinal axis. The distance along the longitudinal axis from the fist end to the second end defines the handle length. A pick head is coupled in a fixed position to the second end of the handle. The pick head has a top, and first and second side edges, which extend away from the top and meet at a bottom point. A primary axis extends from the pick head top to the bottom point. The pick head length is defined by the distance along the primary axis from the pick head top to the bottom point. The length is preferably between 29 and 40 percent of the handle length. The pick head is coupled to the handle at a location along the pick head primary axis proximate to the pick head top. The pick head primary axis is at an acute angle with respect to the longitudinal axis of the handle. The pick head further comprises at least one tab extending from the pick head top toward the handle first end in a generally parallel orientation to the handle longitudinal axis. The tab has a length sufficient to serve as a foot support and as a striking surface. The tab length is preferably at least 8 percent the pick head length and optimally at least 9 percent of the optimal pick head length.

In another aspect of the invention, the pick head curves from the primary axis to the first and second side edges providing the pick with a concave surface facing the handle first end, and a convex surface disposed opposite the concave surface facing away from the handle first end.

In another aspect of the invention, the pick head includes a socket, and the pick handle second end is disposed within the socket.

In another aspect of the invention, the pick head includes a first tab disposed to one side of the socket, and a second tab disposed on the opposite side of the socket. The tabs extend essentially from the socket to the first and second side edges.

In yet another aspect of the invention, the socket includes a top surface, which is generally co-planar with the first and second tabs.

In yet another aspect of the invention, the socket surrounds the second end of the handle.

In yet another aspect of the invention, the pick head further curves from the top to the bottom point.

In yet another aspect of the invention, the pick handle is an axe handle and includes a curvature.

In yet another aspect of the invention, the distance from the first side edge to the second side edge at the pick head top defines the pick head width, the at least one tab preferably has a length of at least 12 percent of the pick head width and optimally has a length of at least 15 percent of the optimal pick head width.

The pick of the present invention is a multiple purpose earth-working tool that is useful in a variety of environments and may be used in a variety of ways. These and other aspects and benefits of the invention will become more apparent upon analysis of the drawings, specification and claims.

### DRAWINGS

FIG. 1 is a side view of one version of the pick of the present invention.

FIG. 2 is a top view of the pick head portion of the pick of the present invention.

### DESCRIPTION

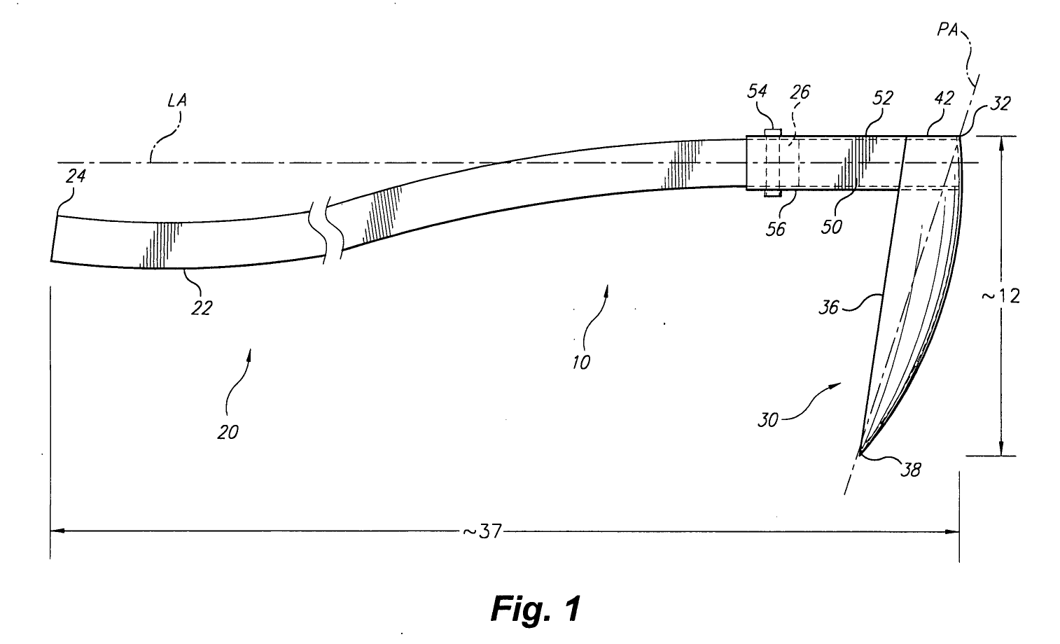

FIG. 1 shows one version of the pick 10 of the present invention in a side view. As is shown, the pick 10 comprises a handle 20 comprising an elongate shaft 22 having a first end 24 and a second end 26, both being disposed generally along a longitudinal axis denoted as LA. The distance along the longitudinal axis LA from the first end 22 to the second end defines the handle length. The handle length is preferably from 34 to 40 inches, and optimally 37 inches. The pick handle may preferably be an axe handle, such as is shown in FIG. 1, and include at least one curvature. The handle 20 includes two curvatures along the length of the handle. The handle is preferably manufactured from a variety of materials such as wood and plastic and can have a variety of curvatures and cross-sectional shapes.

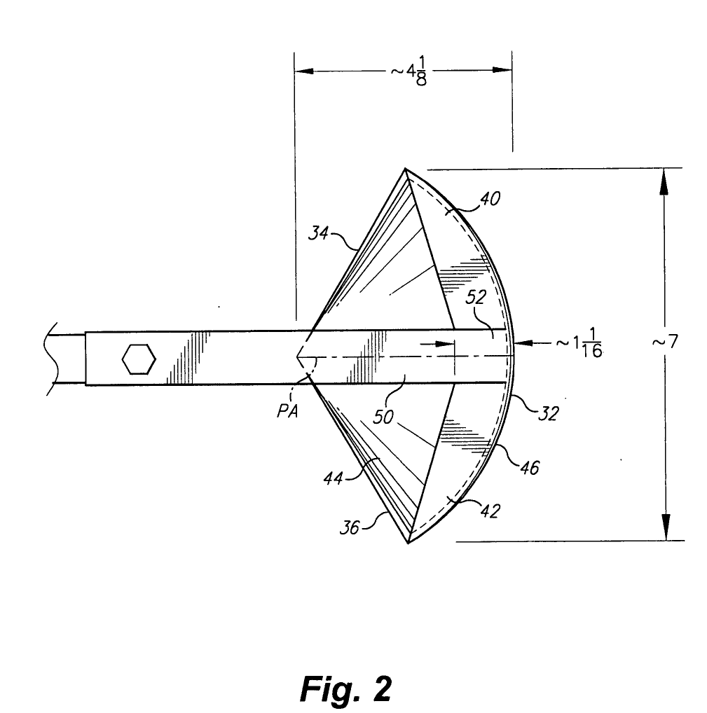

A pick head 30 is coupled in a fixed position to the handle second end 26. The pick head has a top 32, a first side edge 34 shown in FIG. 2, and a second side edge 36 shown in FIGS. 1 and 2. The side edges 34 and 36 extend away from the top 32 and meet at a bottom point 38. A primary axis denoted as PA extends from the pick head top 32 to the bottom point 38. The pick head length is defined by the distance along the primary axis PA from the pick head top 32 to the bottom point 38. The pick head length is preferably between 11.75 and 13.75 inches and is optimally approximately 12.75 inches. The pick head length is preferably between 29 percent and 40 percent of the handle length. The optimal length of the pick head, which is 12.75 inches, is 34 percent of the optimal handle length of 37 inches. The pick head 30 is coupled to the handle 20 at a location along on the pick head primary axis PA proximate to the pick head top 32. The pick head primary axis PA is at an acute angle A with respect to the longitudinal axis of the handle 20, and is disposed in the same plane. The acute angle A is also known as the attack angle and may preferably be between 60 and 80 degrees and is optimally approximately 70 degrees. The pick head primary axis PA bisects the pick head 32 into two symmetrical sides.

As is shown in FIG. 2, the pick head 30 further comprises two tabs 40 and 42, which extend longitudinally from the pick head top 32 toward the handle first end 24 in a generally parallel orientation to the handle longitudinal axis LA. The tabs 40 and 42 have a length sufficient to serve as a foot support and as a striking surface. The length of the tabs at their origin proximate to the primary axis PA is preferably at least one inch or at least 7 percent the pick head 30 length and is optimally at least an inch and one sixteenth inches or at least 8 percent of the optimal pick head 30 length of 12.75 inches. As is shown, the tabs shorten as they extend laterally from their origin proximate to the primary axis to the side edges 34 and 36. The distance from the first side edge to the second side edge at the pick head top defines the pick head width. The pick head width is preferably from 6 to 8 inches and is optimally 7 inches. The tabs preferably have a longitudinal length of at least 12 percent of the pick head width and optimally have a length of at least 15 of the optimal pick head width of 7 inches.

The pick head 30 curves from the primary axis to the first and second side edges 34 and 36, thus providing the pick head 32 with a concave surface 44 facing the handle first end 24, and a convex surface 46 disposed opposite the concave surface 44 facing away from the handle first end 24. As can be seen in FIG. 1, the pick head also preferably has a curvature from the top 32 to the bottom point 38.

The pick head 30 includes a socket 50, and the pick handle second end 26 is disposed within the socket 50. The socket 50 is disposed along the pick head primary axis PA. In this version of the invention, the socket includes a rectangular shape within which the pick handle second end 26 is inserted and fully surrounded. Accordingly, the handle 20 is fixed until requiring replacement. Also in this version of the invention, the first tab 40 is disposed to one side of the socket 50, and the second tab 42 is disposed on the opposite side of the socket 50. The tabs 40 and 42 extend essentially from the socket 50 to the first and second side edges 34 and 36. The socket 50 includes a top surface 52, which is generally co-planar with the first and second tabs 40 and 42. The socket top surface 52 and the tabs 40 and 42 provide a top surface for the pick head 30. A bolt 54 is used to affix the handle second end 26 in the socket 50. As shown in FIG. 1, the bolt extends from the socket top surface 52 to the socket bottom surface 56. The pick head could be coupled to the handle through the use of any number of bolts or other fasteners.

The pick head 30 is preferably manufactured from steel, and may be of a thickness of one-eighth inch or thicker if significant strength and stiffness is desired. The pick head 30 can be cut and formed from a single piece of steel, or could be manufactured from multiple pieces that are welded together. The socket 50 may preferably be disposed between first and second tabs 40 and 42, or could also be disposed directly underneath the tabs.

In use, the pick is typically swung like an axe or pickaxe if the user is driving the pick into compacted material. The pick can both break and excavate the earth in a single swing, unlike other picks, as well as being used after the digging operation by laying the pick head on its side and using the pick head to level the ground that has been excavated. If the earth which is being worked is uncompacted, the pick could be merely be pulled through it, such as using the pick to dig a small trench within which plants or seeds will be planted. The pick is usable as a shovel or as a hoe. However, neither a shovel nor a hoe have the capability to be used as a pick and swung like an axe in a digging operation.

The dimensions of the pick of the present invention have been provided herewith to distinguish the pick from a shovel or a hoe. The pick head length is much longer than that of a hoe, and the handle is much shorter. However, these differences do not prohibit the pick from being used as a hoe, in particular during weeding operations where the earth is quite compacted. In addition to strength and rigidity benefits imparted to the pick head, the tabs also provide functionality to the pick that it would otherwise lack in their absence. The tabs allow the pick to be used as a shovel with the user pushing down on the pick head through an application of force of the user's foot on the tabs. Neither the pick handle length, which is much shorter than that of a shovel, nor the pick head orientation at an acute angle, which is obviously much different than that of a shovel, prohibit the pick from being used as a shovel when necessary. Additionally, when digging in very compacted material the user could drive the pick head 20 into densely compacted material through striking the tabs 40 and 42 and the socket top surface 52 with a hammer. This operation can generally not be performed on a normal shovel and adds further usefulness to the pick.

It is understood that the ranges of dimensions that have been provided are approximate.

Although a specific embodiment of the invention has been shown in FIGS. 1 and 2, and described herein, it is understood that the invention comprises modifications that would not depart from the scope and spirit of the invention. Accordingly, those skilled in the art will appreciate that other changes, modifications, or substitutions are also possible without departing from the scope and spirit of the invention as disclosed in the accompanying claims.

1. A pick comprising:
a handle comprising an elongate shaft having first and second ends disposed generally along a longitudinal axis,
a pick head disposed at the second end of the handle and coupled in a fixed position thereto, the pick head having a top and first and second side edges which extend from the top and meet at a bottom point, a primary axis extending from the pick head top to the bottom point and a length defined by the distance along the primary axis from the pick head top to the bottom point, the length being at least 29 percent of the handle length, the pick head further being coupled to the handle at a location along on the pick head primary axis proximate to the pick head top, the pick head primary axis being at an acute angle with respect to the longitudinal axis of the handle,
the pick head further comprising at least one tab extending from the pick head top toward the handle first end in a generally parallel orientation to the handle longitudinal axis, the tab having a length sufficient to serve as a foot support and as a striking surface, the tab longitudinal length, being defined by the distance the tab extends longitudinally from the top toward the handle first end, is at least 8 percent of the length of the pick head.

2. The pick of claim 1, wherein the pick head curves from the primary axis to the first and second side edges providing the pick with a concave surface facing the handle first end, and a convex surface disposed opposite the concave surface facing away from the handle first end.

3. The pick of claim 1, wherein the pick head includes a socket, the pick handle second end being disposed within the socket.

4. The pick of claim 3, wherein the pick head includes a first tab disposed to one side of the socket, and a second tab disposed on the opposite side of the socket, the tabs extending laterally essentially from the socket to the first and second side edges.

5. The pick of claim 4, wherein the socket includes a top surface which is generally co-planar with the first and second tabs.

6. The pick of claim 3, wherein the socket surrounds the second end of the handle.

7. The pick of claim 1, wherein the pick head further curves from the top to the bottom point.

8. A pick comprising:
a handle comprising an elongate shaft having first and second ends disposed generally along a longitudinal axis,
a pick head disposed at the second end of the handle and coupled in a fixed position thereto, the pick head having a top and first and second side edges which extend from the top and meet at a bottom point, a primary axis extending from the pick head top to the bottom point and a length defined by the distance along the primary axis from the pick head top to the bottom point, the pick head being coupled to the handle at a location along on the pick head primary axis proximate to the pick head top, the pick head primary axis being at an acute angle with respect to the longitudinal axis of the handle, the pick head being curved from the primary axis to the first and second side edges providing the pick with a concave surface facing the handle first end, and a convex surface disposed opposite the concave surface facing away from the handle first end, the pick head further comprising at least one tab extending from the pick head top toward the handle first end in a generally parallel orientation to the handle longitudinal axis, the tab having a longitudinal length sufficient to serve as a foot support and as a striking surface.

9. The pick of claim 8, wherein the pick head includes a socket, the pick handle second end being disposed within the socket.

10. The pick of claim 9, wherein the pick head includes a first tab disposed to one side of the socket, and a second tab disposed on the opposite side of the socket.

11. The pick of claim 10, wherein the tabs extend laterally essentially from the socket to the first and second side, and the tabs longitudinal length, being defined by the distance the tabs extend longitudinally from the top toward the handle first end, is at least 8 percent of the length of the pick head.

12. The pick of claim 10, wherein the socket includes a top surface which is generally co-planar with the first and second tabs.

13. The pick of claim 9, wherein the socket surrounds the second end of the handle.

14. The pick of claim 8, wherein the pick head further curves from the top to the bottom point.

15. The pick of claim 8, wherein the pick head length is at least 29 percent of the handle length.
